(19) United States
(12) Patent Application Publication
(10) Pub. No.: US 2017/0210845 A1
(43) Pub. Date: Jul. 27, 2017

(54) POLYMER COMPOSITION AND PREPARATION METHOD THEREOF

(71) Applicant: Nipsea Technologies Pte. Ltd., Singapore (SG)

(72) Inventors: Shaofeng Wang, Singapore (SG); Jian Hu, Singapore (SG); Swee How Seow, Singapore (SG)

(21) Appl. No.: 15/329,531

(22) PCT Filed: Oct. 9, 2015
(86) PCT No.: PCT/SG2015/050384

§ 371 Date: Jan. 26, 2017

(30) Foreign Application Priority Data
Oct. 10, 2014 (SG) 10201406501R

(51) Int. Cl. C08G 18/67; C09D 5/00; C08G 18/12; C08G 18/66; C08G 18/80; C09D 175/12; C08G 18/77; C09D 175/04; C08G 18/75

(52) U.S. Cl. CPC C08G 18/6755; C09D 175/04; C09D 5/00; C08G 18/12; C08G 18/755; C08G 18/8096; C09D 175/12; C08G 18/778; C08G 18/6692

(57) ABSTRACT

The present invention relates to a polymer having formula (I):

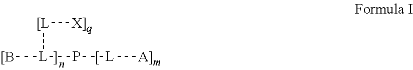

wherein the line “- - - ” represents a covalent bond, or a linkage group selected from: —NRC(O)O—, —C(O)OC(O)—NR—, —C(O)NR—, —NHC(O)NH—, wherein R is H, optionally substituted C1-C6 alkyl, C1-C6 heteroalkyl, carbocycle, aryl, or heteroaryl; P is a polymer comprising y number of peripheral functional groups; L is a linker moiety selected from optionally substituted, aliphatic, branched or cyclic alkyl, aryl, phenyl, or alkylene diphenyl; A is a hydrophobic functional group; B is a hydrophilic functional group, and carboxylate; and X is a cross-linkable functional group; each of m, n and q are greater than zero, and wherein m+n+q≦y, and use of the polymer for preparing coating compositions.

### TECHNICAL FIELD

The present invention relates to a polymer composition for use in coating compositions. Also disclosed herein is a method of preparing such a polymer composition.

### BACKGROUND

Surface fouling by foreign particles or dirt is a common problem encountered by surface-protective coatings. This problem is particularly relevant towards coated surfaces which are routinely exposed to dust, dirt, grime and rain, e.g., external surfaces of motor-vehicles. It is generally desired that these surface-protective coatings are able to repel water, dirt and other foreign particles and/or provide ease of removal of dirt, oil and grime. In this regard, the state of the art provides several known solutions for achieving coated surfaces that provide ease of cleaning.

In one known solution, the surface is coated with a polymer composition or inorganic nanoparticles that have been imparted with hydrophilicity or super-hydrophilicity. The hydrophilicity or super-hydrophilicity allows the coated surface to achieve self-cleaning properties when contacted with water e.g., rain. Specifically, it has been observed that such hydrophilic coatings promote the formation of an even, thin film of water over the coated surface. Water is readily conveyed across and off the coated surface, thereby removing dirt particles entrained or dissolved in water. The formation of the thin water film or the good wettability also prevents formation of streak marks on the coated surface. However, hydrophilic coatings usually possess high surface energy and thus have a greater tendency to absorb dirt. The result is that such coatings are prone to fouling by inorganic'and organic contaminants. Once fouled by dirt, the surface hydrophilicity will be reduced or even disappear. Such problems are commonly encountered by exposed surfaces such as glass. Such contaminants can be difficult to remove from the coating and often ruin the coated surface.

In another known solution, a hydrophobic coating is applied on a surface to achieve clean coating surface. Hydrophobic coatings result in low surface tension, thereby preventing or minimizing the adhesion of foreign particles to coated surfaces. Hydrophobic coatings further provide self-cleaning properties by increasing the water contact angle, thus making it easier for the removal of water droplets from a coated surface. Examples of such hydrophobic coatings include silicones, or siloxanes-based coatings, e.g., a polydimethylsiloxane (PDMS) coating. However, it has been found that conventional silicone-modified coatings remain prone to adhesion or fouling by organic or oil-based contaminants. Moreover, such coatings are also unable to spread water evenly over the coated surface, which results in the formation of dirt streaks and marks.

In other known methods, fluorocarbon surfactants have been admixed into coating compositions to impart ultra low surface tension and oil-repellent characteristics. The addition of the fluorocarbon surfactants allows the coated surface to resist both hydrophilic and hydrophobic contaminants. However, the oil-repellent property imparted by the fluorosurfactant has been found to be somewhat short-lived, ostensibly because the fluorocarbon surfactants are water soluble and tend to dissociate from the coating composition when contacted with solvents such as water or rain (weak acids).

There is a therefore a need to provide a polymer for use in coating compositions which overcome or ameliorate the disadvantages described above.

In particular, there is a need to provide a coating composition capable of achieving a self-cleaning function, and wherein hydrophilic and/or oleophobic properties are relatively longer-lasting or permanent. It is further desired to provide a method for making a polymer and using the polymer for preparing such a coating composition.

### SUMMARY

According to an embodiment, there is provided a method of forming a polymer for use in a coating composition, the method comprising the steps of: a) providing precursor compounds comprising at least one terminal cross-linkable group and at least one additional functional group selected from a hydrophilic functional group, an hydrophobic functional group or a crosslinkable functional group; b) forming a covalent bond between the terminal cross-linkable group of the precursor compound with a peripheral reactive group of a polymer to thereby form a polymer P having the following formula I:

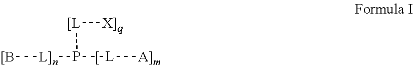

wherein the line “- - - ” represents a covalent bond, or a linkage group selected from: —NRC(O)O—, —C(O)OC(O)—NR—, —C(O)NR—, —NHC(O)NH—, wherein R is H, optionally substituted C₁-C₆ alkyl, C₁-C₆ heteroalkyl, carbocycle, aryl, or heteroaryl;

P is a polymer comprising y number of peripheral functional groups;

L is a linker moiety selected from optionally substituted, aliphatic, branched or cyclic alkyl, aryl, phenyl, or alkylene diphenyl;

A is a hydrophobic functional group;

B is a hydrophilic functional group; and

X is a cross-linkable functional group;

each of m, n and q are integers, wherein m, q and n are greater than zero, and m+n+q≦y.

The disclosed method is advantageous over known methods of grafting hydrophobic and/or hydrophilic groups onto a polymer P, especially a dendritic polymer. In one embodiment, the disclosed method advantageously excludes the use of polar aprotic solvents such as pyridine, N-methyl pyrrolidone (NMP), dimethylformamide (DMF) during the reaction step (a) and/or forming step (b). Such aprotic solvents are highly toxic and the disposal of such reactants imposes significant costs. Some solvents also result in the formation of by-products which may be difficult to isolate or remove from the reactant mixture. By contrast, the disclosed method does not require the use of those highly toxic polar aprotic solvents.

In embodiments, the disclosed method involves the chemical bonding of a precursor compound to a polymer, where the precursor compound contains at least one free isocyanate group (—NCO) for covalent bonding with a reactive group of the polymer backbone, e.g., —OH, —NH₂, NH, etc. Advantageously, the disclosed method can be performed at lower temperatures compared to conventional functionalization techniques, such as a polycondensation process.

In embodiments, the hydrophobic group A is an oleophobic moiety selected to impart oleophobicity and/or low surface tension to the polymer P or a coating prepared from polymer P. The moiety A may be a siloxane moiety such as an alkylsiloxane or a dialkylsiloxane. Moiety A can also be a polysiloxane moiety such as a poly(dimethylsiloxane) moiety. In an embodiment, the moiety A is a fluoro-containing moiety such as a fluorinated alkyl or heteroalkyl.

In one embodiment, step (a) involves reacting a first compound having at least two terminal isocyanate groups with one or more additional compounds, each additional compound having at least one functional group reactive with the isocyanate group and at least one terminal oleophobic, hydrophilic or cross-linkable group. The isocyanate group is advantageously reactive under mild temperature conditions ranging from 15° C. to 100° C. In embodiments, step (a) can be advantageously undertaken under room temperature conditions, i.e., from 20° C. to 30° C., or 25° C. In one embodiment, step (b) is undertaken at temperatures not exceeding 120° C., e.g., at 100° C. or lower, or at 80° C. or lower. This represents a significant improvement over prior art polymer-functionalization techniques, especially dendritic polymer functionalization techniques, some of which require heating the polymer into a melt before reaction with compounds to graft functional groups thereon.

In one embodiment, the disclosed method produces a polymer having formula (I) as defined above. The polymer of formula (I) can be used in the preparation of a coating composition for use as a surface coating. Advantageously, a surface coating prepared therefrom exhibits both oleophobic and hydrophilic properties. In embodiments, a surface coating formed according to the present invention exhibits a hexadecane contact angle of from ≧50° to ≧90° or a water contact angle of from ≦90° to ≦50°.

Further advantageously, the surface coating is capable of dispersing water into an even, thin film (“water spreading effect”). Hence, any dirt coming into contact with the coated surface can be readily washed away with the water. The water spreading effect also prevents the formation of streak marks which may otherwise reduce the transparency of the coated surface and are visually unpleasant.

Advantageously, the polymer composition has both hydrophilic and hydrophobic functional groups. In embodiments, the polymer having formula (I) has at least three distinct types of peripheral functional groups, comprising at least one hydrophilic ‘group, at least one hydrophobic group and at least one cross-linkable functional group, wherein the cross-linkable functional group is distinct from either the hydrophilic group or the hydrophobic group. By controlling the types and ratios of hydrophilic groups (B)/hydrophobic groups (A), the coating surface can repel both water and organic oil dirt; or can be oil-repellent (oleophobic) while retaining hydrophilic nature to achieve a water spreading effect. Organic, oil dirt can be organic contaminants, oil-based or lipid-based contaminants, organic contaminants e.g., carbon, soot, or carbon black, and hydrophilic dirt can be inorganic dirt particles, e.g., dirt, mud, sleet, etc.

Advantageously, the coating composition prepared using a polymer of formula (I) has been found to possess low surface energy of ≦36 mJ/m², more advantageously less or equal to 20 mJ/m².

Another advantage of the disclosed method and polymer is that the oleophobic functional groups, the hydrophilic functional groups, and the cross-linkable functional groups are all covalently attached to the polymer backbone. In one embodiment, these functional groups are covalently linked to a linker moiety, which is itself covalently bonded to the polymer backbone (e.g., via reaction with a peripheral reactive group of the polymer backbone). A useful technical result of the hydrophilic groups is that they can render the polymer composition aqueous-dispersible.

In another aspect, there is provided a hyperbranched polymer having the following formula I:

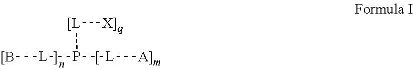

wherein the line “- - - ” represents a covalent bond, or a linkage group selected from: —NRC(O)O—, —C(O)OC(O)—NR—, —C(O)NR—, —NHC(O)NH—, wherein R is H, optionally substituted C₁-C₆ alkyl, C₁-C₆ heteroalkyl, carbocycle, aryl, or heteroaryl;

P is a hyperbranched polymer comprising y number of peripheral functional groups;

L is a linker moiety selected from optionally substituted, aliphatic, branched or cyclic alkyl, aryl, phenyl, or alkylene diphenyl;

A is a hydrophobic functional group;

B is a hydrophilic functional group selected from the group consisting of: alkoxy, amino, amide, ammonium, carboxyl, carboxylate, phosphoric acid groups, sulfonic acid groups and combinations thereof; and

X is a cross-linkable functional group;

each of m, n and q are integers, wherein m, q and n are each greater than zero, m+n+q≦y, and wherein the following conditions are met:
8≦y≦64;
0.1y≦m≦0.6y;
0.1y≦n≦0.5y;
0.01≦q≦0.5y.

In embodiments, the hydrophobic group A is an oleophobic moiety selected to impart oleophobicity and/or low surface tension to the polymer P or a coating prepared from polymer P. The moiety A may be a siloxane moiety such as an alkylsiloxane or a dialkylsiloxane. Moiety A can be a polysiloxane moiety such as a poly(dimethylsiloxane) moiety. In an embodiment, moiety A can also be a fluoro-containing moiety. For instance, moiety A may be a fluorine-containing aliphatic, a fluoroalkyl moiety, a fluorinated heteroalkyl moiety, or a perfluoroalkyl moiety. The fluorinated alkyl or heteroalkyl moieties may comprise hydrocarbon backbones having from C₁ to C₈₀ carbon length. In embodiments, the fluoroalkyl moiety may be a C1-12 perfluoroalkyl group. In other embodiments, the moiety A may comprise fluorinated alkoxy groups wherein the fluorinated alkoxy groups may comprise 10 to 80 carbons.

Advantageously, the presence of the cross-linkable groups X assists in the formation of a densely cross-linked macromolecular network of polymers having formula (I), which bind the olephobic and hydrophilic functional groups in place. The cross-linked macromolecular structure may also prevent hydrolysis of the covalent bonds holding the functional groups in place.

In another aspect, there is provided a compound having a formula (II):

O═C—N-L - - - G Formula II

wherein the line “- - - ” represents a covalent bond, or a linkage group selected from: —NRC(O)O—, —C(O)OC(O)—NR—, —C(O)NR—, —NHC(O)NH—, wherein R is H, optionally substituted C₁-C₆ alkyl, C₁-C₆ heteroalkyl, carbocycle, aryl, or heteroaryl;

L is a linker moiety selected from optionally substituted, aliphatic, branched or cyclic alkyl, aryl, phenyl, or alkylene diphenyl; and

G is a hydrophobic functional group as defined above for group A, a functional group selected from alkoxy, amino, amide, ammonium, carboxyl, carboxylate, phosphonate, sulfonate, epoxy, or a cross-linkable functional group.

In one embodiment, the compounds of Formula II can be employed as precursor compounds for covalent bonding with a peripheral reactive group of another polymer P to thereby graft the functional group G onto the polymer P. In one embodiment, the precursor compounds can be advantageously formed via reaction of a di-, tri-, or poly-isocyanate compound with a fluorinated alcohol, an alkoxy alcohol, an epoxide alcohol, an organo-functional alkoxysilane, or a hydroxyl acrylate.

Where G is a cross-linkable functional group, it can be selected from the group consisting of isocyanate, blocked isocyanate, acrylate, epoxy, carbodiimide, aziridine, aceto acetyl, alkoxysilane, and silane.

In the embodiments disclosed herein, the y number of peripheral groups on polymer P can be hydroxyl groups. It is not necessary for all hydroxyl groups to be covalently bonded to a precursor compound. In embodiments the polymer of formula I may comprise [y−(m+n+q)] number of unreacted hydroxyl groups.

### Definitions

As used herein, the term “alkyl” includes within its meaning monovalent (“alkyl”) and divalent (“alkylene”) straight chain or branched chain saturated aliphatic groups having from 1 to 12 carbon atoms, e.g., 1, 2, 3, 4, 5, 6, 7, 8, 9, 10, 11 or 12 carbon atoms. For example, the term alkyl includes, but is not limited to, methyl, ethyl, 1-propyl, isopropyl, 1-butyl, 2-butyl, isobutyl, tert-butyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl, undecyl, dodecyl and the like. All alkyl groups defined in the present specification, unless otherwise indicated, may also be optionally substituted.

The term “alcohol” includes within its meaning a group that contains one or more hydroxyl moieties.

The term “alkoxy” or variants such as “alkoxide” as used herein refers to an —O-alkyl radical. Representative examples include, for example, methoxy, ethoxy, n-propoxy, isopropoxy, tert-butoxy, and the like.

The term “aryl”, or variants such as “aromatic group” or “arylene” as used herein refers to monovalent (“aryl”) and divalent (“arylene”) single, polynuclear, conjugated and fused residues of aromatic hydrocarbons having from 6 to 10 carbon atoms. Such groups include, for example, phenyl, biphenyl, naphthyl, phenanthrenyl, and the like. Aryl groups may be optionally substituted.

The term “amino” includes an amine group (i.e., —NH₂) or a substituted amine group. The term “amino” comprises primary amino groups, secondary amino groups and tertiary amino groups.

The term “carbocycle”, or variants such as “carbocyclic ring” as used herein, includes within its meaning any stable 3, 4, 5, 6, or 7-membered monocyclic or bicyclic or 7, 8, 9, 10, 11, 12, or 13-membered bicyclic or tricyclic, any of which may be saturated, partially unsaturated, or aromatic. Examples of such carbocycles include, but are not limited to, cyclopropyl, cyclobutyl, cyclopentyl, cyclohexyl, cycloheptyl, adamantyl, cyclooctyl, [3.3.0]bicyclooctane, [4.3.0]bicyclononane, [4.4.0]bicyclodecane (decalin), [2.2.2]bicyclooctane, fluorenyl, phenyl, naphthyl, indanyl, adamantyl, or tetrahydronaphthyl (tetralin). Preferred carbocycles, unless otherwise specified, are cyclopropyl, cyclobutyl, cyclopentyl, cyclohexyl, phenyl, naphthyl, and indanyl. When the term “carbocycle” is used, it is intended to include “aryl”. Unless otherwise indicated, carbocycles may be optionally substituted.

As used herein, the term “alkenyl” refers to divalent straight chain or branched chain unsaturated aliphatic groups containing at least one carbon-carbon double bond and having from 2 to 6 carbon atoms, eg, 2, 3, 4, 5 or 6 carbon atoms. For example, the term alkenyl includes, but is not limited to, ethenyl, propenyl, butenyl, 1-butenyl, 2-butenyl, 2-methylpropenyl, 1-pentenyl, 2-pentenyl, 2-methylbut-1-enyl, 3-methylbut-1-enyl, 2-methylbut-2-enyl, 1-hexenyl, 2-hexenyl, 3-hexenyl, 2,2-dimethyl-2-butenyl, 2-methyl-2-hexenyl, 3-methyl-1-pentenyl, 1,5-hexadienyl and the like. Alkenyl groups may be optionally substituted.

The term “heterocycle” includes within its meaning a group comprising a covalently closed ring wherein at least one atom forming the ring is a carbon atom and at least one atom forming the ring is a heteroatom. Heterocyclic rings may be formed by three, four, five, six, seven, eight, nine, or more than nine atoms, any of which may be saturated, partially unsaturated, or aromatic. Any number of those atoms may be heteroatoms (i.e., a heterocyclic ring may comprise one, two, three, four, five, six, seven, eight, nine, or more than nine heteroatoms). Herein, whenever the number of carbon atoms in a heterocycle is indicated (e.g., C1-C6 heterocycle), at least one other atom (the heteroatom) must be present in the ring. Designations such as “C1-C6 heterocycle” refer only to the number of carbon atoms in the ring and do not refer to the total number of atoms in the ring. It is understood that the heterocylic ring will have additional heteroatoms in the ring. In heterocycles comprising two or more heteroatoms, those two or more heteroatoms may be the same or different from one another. Heterocycles may be optionally substituted. Binding to a heterocycle can be at a heteroatom or via a carbon atom. Examples of heterocycles include heterocycloalkyls (where the ring contains fully saturated bonds) and heterocycloalkenyls (where the ring contains one or more unsaturated bonds) such as, but are not limited to the following:

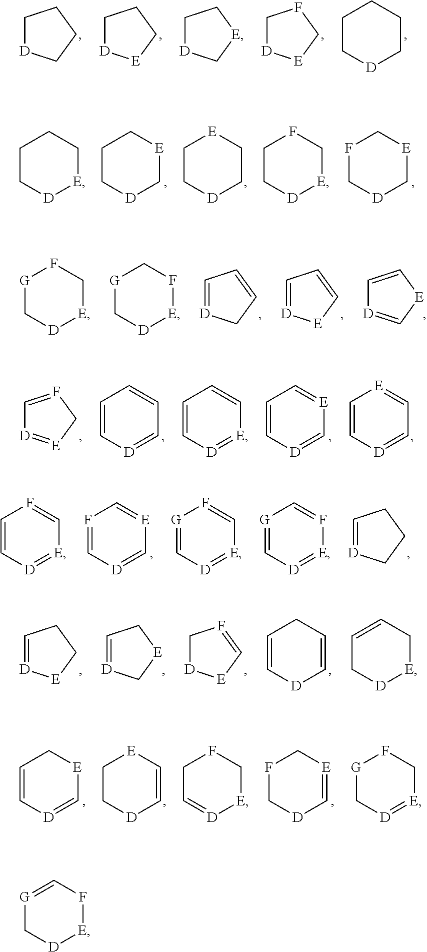

wherein D, E, F, and G independently represent a heteroatom. Each of D, E, F, and G may be the same or different from one another.

The term “imine” includes within its meaning the reaction product of an amine or ammonia and an aldehyde or ketone. This reaction results in a molecule with at least one C═N group.

The term “perfluoroalkyl” includes within its meaning an alkyl group in which all hydrogen atoms are replaced by a fluorine group.

The term “ring” refers to any covalently closed structure.

When compounded chemical names, e.g. “arylalkyl” and “arylimine” are used herein, they are understood to have a specific connectivity to the core of the chemical structure. The group listed farthest to the right (e.g. alkyl in “arylalkyl”), is the group that is directly connected to the core. Thus, an “arylalkyl” group, for example, is an alkyl group substituted with an aryl group (e.g. phenylmethyl (i.e., benzyl)) and the alkyl group is attached to the core. An “alkylaryl” group is an aryl group substituted with an alkyl group (e.g., p-methylphenyl (i.e., p-tolyl)) and the aryl group is attached to the core.

The term “cycloalkyl” as used herein refers to a non-aromatic mono- or multicyclic ring system comprising about 3 to about 10 carbon atoms. The cycloalkyl can be optionally substituted with one or more “ring system substituents” which may be the same or different, and are as defined herein. Non-limiting examples of suitable monocyclic cycloalkyls include cyclopropyl, cyclopentyl, cyclohexyl, cycloheptyl and the like. Non-limiting examples of suitable multicyclic cycloalkyls include 1-decalinyl, norbornyl, adamantyl and the like. Further non-limiting examples of cycloalkyl include the following:

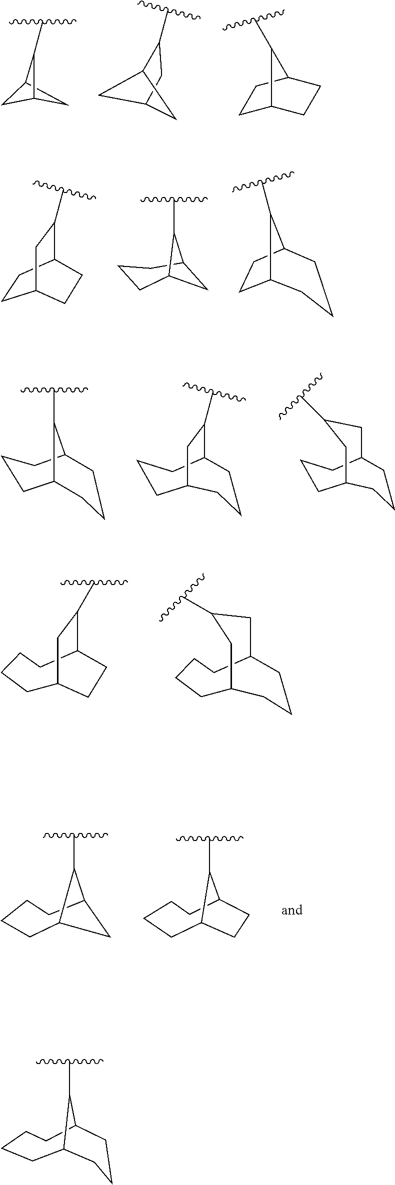

The term “cycloalkenyl” as used herein refers to a non-aromatic mono or multicyclic ring system comprising about 3 to about 10 carbon atoms which contains at least one carbon-carbon double bond. Non-limiting examples of suitable monocyclic cycloalkenyls include cyclopentenyl, cyclohexenyl, cyclohepta-1,3-dienyl, and the like. Non-limiting example of a suitable multicyclic cycloalkenyl is norbornylenyl, as well as unsaturated moieties of the examples shown above for cycloalkyl. Cycloalkenyl groups may be optionally substituted.

The term “heteroalkyl” as used herein refers to an alkyl moiety as defined above, having one or more carbon atoms, for example 1, 2, 3, 4, 5, 6, 7, 8, 9, 10 carbon atoms, replaced with one or more heteroatoms, which may be the same or different, where the point of attachment to the remainder of the molecule is through a carbon atom of the heteroalkyl radical, or the heteroatom. Suitable heteroatoms include O, S, and N. Non-limiting examples include ethers, thioethers, amines, hydroxymethyl, 3-hydroxypropyl, 1,2-dihydroxyethyl, 2-methoxyethyl, 2-aminoethyl, 2-dimethylaminoethyl, and the like. Heteroalkyl groups may be optionally substituted.

The term “heteroaryl” as used herein refers to an aromatic monocyclic or multicyclic ring system comprising about 5 to about 14 ring atoms, preferably about 5 to about 10 ring atoms, in which one or more of the ring atoms is an element other than carbon, for example nitrogen, oxygen or sulfur, alone or in combination. “Heteroaryl” may also include a heteroaryl as defined above fused to an aryl as defined above. Non- limiting examples of suitable heteroaryls include pyridyl, pyrazinyl, furanyl, thienyl, pyrimidinyl, pyridone (including N-substituted pyridones), isoxazolyl, isothiazolyl, oxazolyl, thiazolyl, pyrazolyl, furazanyl, pyrrolyl, pyrazolyl, triazolyl, 1,2,4-thiadiazolyl, pyrazinyl, pyridazinyl, quinoxalinyl, phthalazinyl, oxindolyl, imidazo[1,2-a]pyridinyl, imidazo[2,1-b]thiazolyl, benzofurazanyl, indolyl, azaindolyl, benzimidazolyl, benzothienyl, quinolinyl, imidazolyl, thienopyridyl, quinazolinyl, thienopyrimidyl, pyrrolopyridyl, imidazopyridyl, isoquinolinyl, benzoazaindolyl, 1,2,4-triazinyl, benzothiazolyl and the like. The term “heteroaryl” also refers to partially saturated heteroaryl moieties such as, for example, tetrahydroisoquinolyl, tetrahydroquinolyl and the like. Heteroaryl groups may be optionally substituted.

The term “cyclic group” as used herein refers to an aryl, heteroaryl, cycloalkyl, cycloalkenyl or heterocycle as defined above. Cyclic groups may be optionally substituted.

The term “optionally substituted” as used herein means the group to which this term refers may be unsubstituted, or may be substituted with one or more groups other than hydrogen provided that the indicated atom's normal valency is not exceeded, and that the substitution results in a stable compound. Such groups may be, for example, halogen, hydroxy, oxo, cyano, nitro, alkyl, alkoxy, haloalkyl, haloalkoxy, arylalkoxy, alkylthio, hydroxyalkyl, alkoxyalkyl, cycloalkyl, cycloalkylalkoxy, alkanoyl, alkoxycarbonyl, alkylsulfonyl, alkylsulfonyloxy, alkylsulfonylalkyl, arylsulfonyl, arylsulfonyloxy, arylsulfonylalkyl, alkylsulfonamido, alkylamido, alkylsulfonamidoalkyl, alkylamidoalkyl, arylsulfonamido, arylcarboxamido, arylsulfonamidoalkyl, arylcarboxamidoalkyl, aroyl, aroylalkyl arylalkanoyl, acyl, aryl, arylalkyl, or alkylaminoalkyl.

Any carbon or heteroatom with unsatisfied valences in the text, schemes, examples, structural formulae, and any Tables herein is assumed to have the hydrogen atom or atoms to satisfy the valences.

The expression “aqueous-dispersible”, in the context of the present specification, is interchangeably used with the expressions “aqueous-borne”, “aqueous-based”, “water-based” or “water-dispersible”, and which describes a polymer composition that is either substantially or completely miscible or dispersible in an aqueous medium such as water.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components, of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### BRIEF DESCRIPTION OF DRAWINGS

FIG. 1 is a schematic reaction scheme showing an exemplary, non-limiting, reaction mechanism associated with the disclosed method.

### DETAILED DISCLOSURE OF EMBODIMENTS

Illustrative, non-limiting embodiments of the method and polymer disclosed above will now be described in greater detail.

In embodiments, the polymer P having reactive peripheral groups can be selected from straight chain, branched, star-shaped, hyper-branched, ultra-branched dendritic polymers or dendrimers. In one embodiment, the polymer P is a hyperbranched, hydroxyl-terminated dendritic polyester polyol having from about 8 to about 64 theoretical pendant/peripheral —OH groups. In embodiments, the dendritic or hyperbranched polyester may comprise about 8, 16, 32, or 64 peripheral groups. In embodiments, the polymer P may be a second, third, or fourth generation dendritic polyester polyol.

The dendritic polymer may be substantially globular in shape and may have a dispersity [Mw/Mn] of greater than or equal to 1, e.g., from 1 to 1.8, from 1 to 1.5, or from 1 to 1.3. In embodiments, the dispersity (or also known as polydispersity index, PDI) may depend on the generation of the dendritic polymer. In embodiments the dispersity of polymer P may be selected from 1.1, 1.2, 1.3, 1.4, 1.5, 1.6, 1.7, 1.8, or 1.9. In embodiments, the dendritic polymer may have a hydroxyl value ranging from 300 to 550 mg KOH/g, 300 to 340 mg KOH/g, 470 to 500 mg KOH/g, or 490 to 530 mg KOH/g.

In other embodiments, the polymer P is selected from a polyester, a polysiloxane, a polyacrylate, an alkyd or mixtures thereof. In embodiments, the polymer P is selected to contain pendant reactive groups having hydroxyl, silane, alkoxysilane, carboxylate (—COOH) or amine functionality.

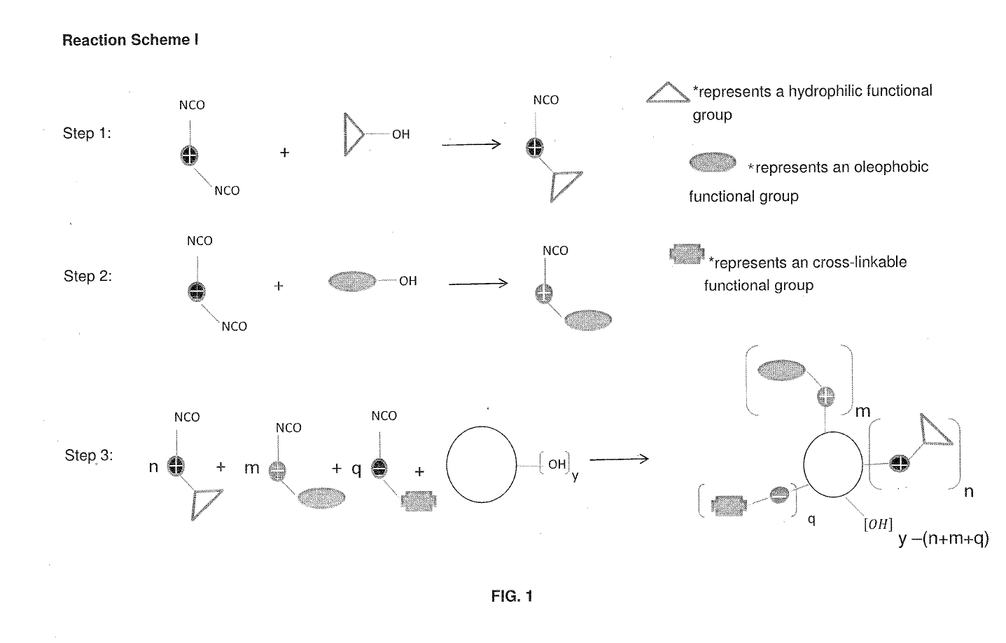

In embodiments, the forming step (b) of the disclosed method is undertaken at stoichiometric conditions to form the polymer of formula (I), wherein m is between 0.01 to 0.6y, such as, 0.02y, 0.03y, 0.04y, 0.05y, 0.06y, 0.07y, 0.08y, 0.09y and 0.1 y. In other embodiments the integer m is between 0.1 y to 0.6 y, e.g., 0.1 y, 0.2 y, 0.3 y, 0.4 y, 0.5 y and 0.6 y. In one embodiment, about 10% to 60% of the pendant reactive groups are covalently bonded to a precursor compound having oleophobic functionality. In preferred embodiments, the forming step (b) is undertaken at stoichiometric conditions such that m is between 0.01 y to 0.4 y, e.g., 0.1 y, 0.2 y, 0.3 y, and 0.4 y. In embodiments, about 1% to about 40% of the pendant groups are covalently bound to the oleophobic moiety. Appropriate stoichiometric conditions/ratios can be derived or calculated by a person skilled in the art in view of the reaction chemistry discussed herein, see in particular, FIG. 1, Scheme I.

In embodiments, the forming step (b) is undertaken at stoichiometric conditions to form the polymer of formula (I) wherein n is between 0.1 y to 0.5 y, e.g., 0.1 y, 0.2 y, 0.3 y, 0.4 y and 0.5y. That is, in one embodiment, it about 10% to about 50% of the pendant reactive groups are covalently bonded to a precursor compound having hydrophilic functionality/hydrophilic moiety. In other embodiments, appropriate stoichiometric conditions are provided such that from about 10% to about 40%, from about 10% to about 30%, from about 10% to about 20%, from about 20% to about 40%, or from about 20% to about 30% of the pendant reactive groups are covalently bonded to a precursor compound having a terminal hydrophilic group.

In embodiments, the forming step (b) of the disclosed method is undertaken at stoichiometric conditions to form the polymer of formula (I), wherein q is from 0 to 0.5y, or from 0.1y to 0.5y. In some embodiments, appropriate stoichiometric conditions are provided such that at least 1%, 2%, 3%, 4%, 5%, 6%, 7%, 8%, 9%, or 10% of the pendant reactive groups of polymer P are covalently bound to the cross-linking moiety X. In other embodiments, about 20%, about 25%, about 30%, about 35%, about 40%, about 45% or about 50% of the reactive groups of polymer P are covalently bound to the cross-linking moiety X. In embodiments, the fraction of cross-linking moiety X is about 20% to about 40% of the total peripheral functional groups. Advantageously, it has been found that by providing substituting at least 20-40% of the peripheral groups with a cross-linkable moiety X, the polymer is capable of forming a coating which exhibits good adhesive properties to a surface, without compromising its hardness or water/oil repellency. It has also been found that a coating prepared from such the disclosed polymer is able to retain its oleophobic and/or hydrophilic properties for an extended period of time.

The linker moiety L may be selected from the group consisting of: alkyl, cycloalkyl, aryl, and substituted aryl. In embodiments, L is selected from optionally substituted aliphatic C₁₋₆ alkyl, optionally substituted C₃-C₈ cycloalkyl, methylbenzene, or diphenyl. In one embodiment, the cycloalkyl may be a C₃-C₈ cycloalkyl substituted with C₁₋₃ alkyl at two or more ring carbons.

In embodiments, L may be selected from the group consisting of:

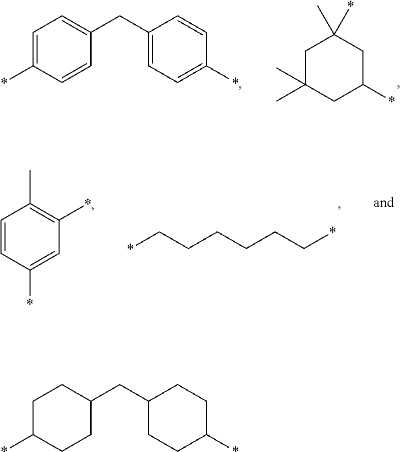

wherein * denotes an attachment point.

In one embodiment, the hydrophilic functional group B is selected from a group consisting of alkoxy, amino, amide, ammonium, carboxyl, phosphoric acid groups, sulfonic acid groups, carboxylate, and combinations thereof. In other embodiments, the hydrophilic functional group B is selected from primary amino groups, secondary amino groups, tertiary amino groups, quaternary ammonium salt groups, amide groups, carboxyl groups, carboxylate groups, ethylene oxide groups, propylene oxide groups, sulfonic acid groups, phosphoric acid groups, and combinations thereof.

In one embodiment, moiety B at least comprises alkoxy groups

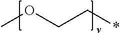

and further comprises at least one or more of the following groups:

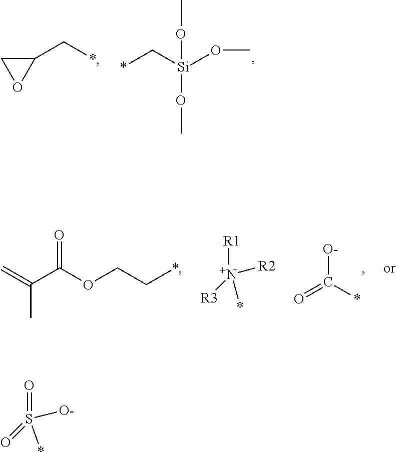

wherein * denotes the point of attachment; v is an integer from 1 to 50; R1, R2, and R3, being same or different, is independently H, alkyl, alkenyl, alkynl, aryl, or heteroaryl.

In embodiments, the integer v may be selected from 5 to 50, 5 to 45, 5 to 40, 5 to 35, 5 to 30, 5 to 25, 5 to 20, 5 to 15, 5 to 10, 10 to 50, 15 to 50, 20 to 50, 25 to 50, 30 to 50, 35 to 50, 40 to 50, or 45 to 50. In embodiments, the integer v is selected from 5 to 25.

In embodiments, step (a) comprises a step of reacting the compound comprising said at least two cross-linkable terminal groups with a fluorinated alcohol and an alkoxy-alcohol. Advantageously, step (a) results in the formation of a mixture of precursor compounds, each terminated with at least one cross-linkable terminal group and at least one terminal fluorinated moiety or one terminal alkoxy moiety. In one embodiment, the fluorinated alcohol is a perfluoralkyl alcohol. In another embodiment, the fluorinated alcohol is a 2-(perfluroalkyl)-ethanol (PFE). In embodiments, the alkoxy alcohol is a polyalkylene oxide compound, such as polyethylene oxide and polypropylene oxide. In one embodiment, the polyalkoxy alcohol is polyethylene oxide, e.g., polyethylene glycol (PEG). In an exemplary embodiment, the polyethylene oxide is methoxypolyethylene glycol (MPEG).

In other embodiments, step (a) comprises reacting the compound comprising at least two cross-linkable terminal groups with a fluorinated alcohol; a polyethylene oxide; and one or more additional compounds selected from the group consisting of: epoxide alcohol, organofunctional-alkoxysilane, alkyl acrylate, cyclic amide, hydroxyl-acids or their salts (e.g. hydroxyl-sulfonates, hydroxy-phosphonates, hydroxy-carboxylates), dicarboxylic acids or their salts, and mixtures thereof.

Advantageously, in this embodiment, a mixture of precursor compounds can be formed, wherein at least a portion of said precursor compounds have at least one terminal cross-linking group and at least one terminal polyalkoxy group; at least a portion of the precursor compounds have a terminal cross-linking group and at least one terminal fluorocarbon group; and at least a portion of the precursor compounds have a terminal cross-linking group and at least one terminal isocyanate, silane, acrylate, carboxylate, or epoxide group. Suitable organofunctional-alkoxysilanes may be of the formula: Y-L-Si(OX)₃, wherein Y is an organo-functional group e.g., NH₂ and (OX) is a hydrolysable group e.g., (OCH₃).

In a particular embodiment, step (a) comprises reacting the compound comprising at least two cross-linkable functional group with: a fluorinated alcohol; a polyethylene oxide; and aminoalkoxysilane.

In another embodiment, step (a) comprises reacting the compound comprising at least two cross-linkable functional group with: a fluorinated alcohol; a polyethylene oxide; an epoxide alcohol; and aminoalkoxysilane.

Prior to step (b), the disclosed method may further comprise a step (a1) of reacting said polymer P having y number of peripheral groups with caprolactam or ε-caprolactone to form a chain extended polymer P with y number of peripheral groups. The chain extension step may be performed under suitable ring-opening catalysts, e.g., dibutyltin dilaurate or stannous octoate. In one embodiment, after chain extension, the polymer P exhibits y number, of terminal hydroxyl groups. Advantageously, the chain extension with caprolactone or caprolactam introduces at least one alkoxy functional group along the pendant reactive chain, which increases the miscibility of the polymer with solvents, e.g., acetone.

Optional embodiments of the disclosed polymer having the formula I

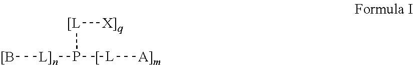

shall now be disclosed.

In one embodiment, polymer P is substituted in a manner which satisfies the following conditions:

8≦y≦64;

0.01 y≦m≦0.6 y;

0.1 y≦n≦0.5 y;

0.01≦q≦0.5 y;

provided that m+n+q≦y.

In embodiments, y is (inclusive of end points) from 8 to 16, 8 to 32, 6 to 64, 16 to 32, 16 to 64, or 32 to 64. In another embodiment, polymer P is substituted in a manner which satisfies the following conditions:

8≦y≦64;

0.01 y≦m≦0.4 y;

0.2 y≦n≦0.4 y;

0.1≦q≦0.5 y;

provided that m+n+q≦y.

In embodiments, the integer m may be selected from 0.1y, 0.2y, 0.3y, 0.4y, 0.5y or 0.6y. In embodiments, the integer n may be selected from 0.1y, 0.2y, 0.3y, 0.4y, or 0.5y; and q may be from about 0.2y to about 0.4y.

In embodiments, the moiety A is an oleophobic moiety selected to impart oleophobicity and/or low surface tension to the polymer P. The moiety A may be a siloxane moiety such as alkylsiloxane or dialkylsiloxane. Moiety A can also be a polysiloxane moiety such as a poly(dimethylsiloxane) moiety. In embodiments, the moiety A is a fluorinated carbon moiety comprising a heteroalkyl backbone optionally substituted with one or more hydroxyl or fluoro groups, wherein one or more carbon atoms in the backbone are substituted by oxygen. Exemplary fluorinated moieties can be but are not limited to:
*—CH₂CF₂O(CH₂CF₂O)ₐ(CF₂O)_{b}CF₂CH₃,
*—(CH₂CH₂O)ₐCH₂CF₂O(CH₂CF₂O)_{c}(CF₂O)_{c}CF₂CH₂O(CH₂CH₂)_{d}CH₃, CF₃ (CF2)ₐ(CH₂)_{b}—*,
CF₃O(CF₂CF₂O)ₐ(CF₂O)_{b}CF₂—(CH₂)_{c}—*,
   wherein each of a, b, c and d are integers, independently selected from 1, 2, 3, 4, 5, 6, 7, 8, 9 or 10 and wherein -* denotes an attachment point.

In one embodiment, the moiety A is a fluorinated moiety having the following Formula III CF₃(CF₂)ᵤCH₂CH₂—, wherein u is an integer from 1 to 12. In embodiments, u is selected from 1, 2, 3, 4, 5, 6, 7, 8, 9, 10, 11 or 12 or a range selected from a combination of such integers.

In one embodiment of the disclosed polymer, moiety B is as defined above. In embodiments, moiety B comprises at least alkoxy groups

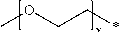

and additionally comprises at least one or more of the following groups:

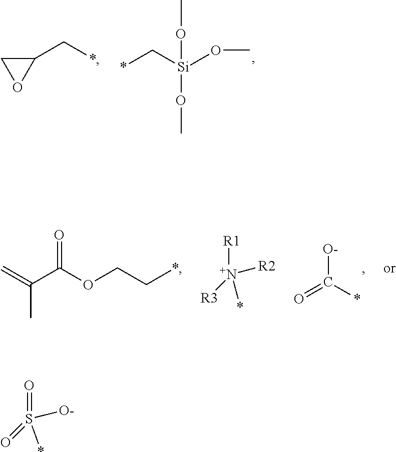

wherein * denotes the point of attachment; v is an integer from 1 to 50; R1, R2, and R3, being same or different, is independently H, alkyl, alkenyl, alkynl, aryl, or heteroaryl. The integer v may be selected from 5 to 50, 5 to 45, 5 to 40, 5 to 35, 5 to 30, 5 to 25, 5 to 20, 5 to 15, 5 to 10, 10 to 50, 15 to 50, 20 to 50, 25 to 50, 30 to 50, 35 to 50, 40 to 50, or 45 to 50. In embodiments, the integer v is selected from 5 to 25.

In embodiments, the cross-linking group X is selected from the group consisting of isocyanate, blocked isocyanate, acrylate, epoxy, carbodiimide, aziridine, acetoacetyl, alkoxysilane, silane and mixtures thereof. In particular embodiments, the cross-linking group X is selected from isocyanate, epoxy, silane, alkoxysilane, silane having hydrolysable or labile leaving groups, e.g., halogen groups or combinations thereof. In one embodiment, the cross-linkable group X is an isocyanate group. In another embodiment, the cross-linkable group X is represented by the following group:

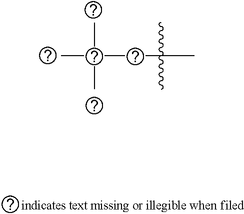

wherein R⁴, R⁵, R⁶, R⁷, being same or different, are independently, halogen (e.g., F, Br, Cl, and I), H, or optionally substituted C₁-C₁₀ alkyl, alkenyl, alkynl, aryl, or heteroaryl. In one embodiment, group X is represented by

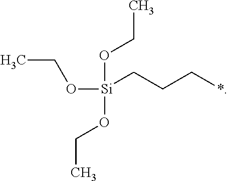

In one embodiment, where an epoxy cross-linker group is preferred for expression, step (a) may comprise reaction of an alcohol epoxide with a diisocyanate compound to yield a precursor compound having a terminal isocyanate group and a terminal epoxy group (epoxy-functionalized precursor). The terminal isocyanate of this precursor compound may thereafter be reacted with a peripheral functional group of the polymer P (e.g., —OH) to thereby graft the epoxy functional group onto the polymer P. In one embodiment, the cross-linking moiety X is a blocked isocyanate group. Exemplary blocked isocyanates may include but are not limited to active hydrogen-blocked isocyanates, malonic ester-blocked isocyanates, diisopropyl amine-blocked isocyanates, 3,5 dimethylpyrazole (DMP)-blocked isocyanates, t-butyl benzylamine-blocked isocyanates.

The functionalized precursor compounds may be reacted concurrently or sequentially with the polymer P. For instance, in one embodiment, a silane precursor compound having at least one terminal isocyanate group is first reacted with the polymer P, followed by reaction of other functionalized precursors.

In embodiments, the cross-linking group X is selected to be cross-linkable under room temperature conditions, e.g., isocyanate, epoxy and silane groups. Unless indicated otherwise, room temperature conditions can refer to temperatures of from about 20° C. to about 30° C., including 21° C., 22° C., 23° C., 24° C., 25° C., 26° C., 27° C., 28° C., 29° C. and 30° C. In another embodiment, the cross-linking group X comprises an unsaturated, radiation curable, cross-linking group, e.g. acrylate.

In other embodiments, the polymer P may additionally comprise one or more photosensitive moieties selected from the group consisting of: derivatives of substituted benzophenones or acetophenones, allyl benzoylbenzoates and benzophenones.

In embodiments, there is disclosed a hyperbranched, globular polyester polyol having from about 16 to about 64 peripheral hydroxyl groups, wherein about 5% to 25% of the peripheral hydroxyl groups are covalently bound to an oleophobic moiety as disclosed herein, about 10 to 50% of the peripheral hydroxyl groups are covalently bound to a hydrophilic moiety as disclosed herein; and about 20% to about 40% of the the peripheral hydroxyl groups are covalently bound to a cross-linkable moiety as disclosed herein, wherein the total percentage of substitution is 100%.

### Coating Composition

The disclosed polymer may be used to prepare an organic solvent-based coating composition or a coating composition that is aqueous-dispersible. The coating composition may be advantageously formulated as a stable, one-pot/one-pack coating composition. The resultant coating composition may be moisture-curable and/or UV curable at room temperature.

In one embodiment, the coating composition comprises a polymer P that has been modified with hydrophilic groups, oleophobic groups, and cross-linker groups as described, above or has been prepared by the methods described above, and one or more cross-linker compounds, wherein the coating composition is provided as a one-pot formulation.

Suitable cross-linker compounds to be included in the one-pot formulation may be selected from isocyanates, diisocyanates, triisocyanates, isocyanurates, polyisocyanates, blocked isocyanates, melamine formaldehydes, and mixtures thereof. In one embodiment, the cross-linker compound is selected to be one which is capable of reacting with or forming a covalent bond with the pendant cross-linking functional group X of the polymer P (e.g., —NCO). In embodiments, the cross-linker compound is selected to be one which is capable of reacting or forming covalent bonds with the un-modified peripheral reactive groups of polymer P (e.g., —OH, —NH₂).

The one pack formulation may further contain one or more additives, including a photoinitiator compound, a UV-stabilizer compound, cross-linking catalysts, nanoparticles and/or mixtures thereof. The nanoparticle can be selected from ceramic particles or inorganic minerals. In embodiments, the nanoparticle is selected from metallic and/or non-metallic oxides including but not limited to calcium oxide, magnesium oxide, beryllium oxide, aluminum oxide, zinc oxide, silicon oxides, and their mixtures thereof. In one embodiment, the nanoparticle is silicon dioxide. Advantageously, the addition of the silicon dioxide nanoparticles can improve the hardness of the coating and enhance hydrophilic properties, which further improve the coating's resistance to dirt.

In embodiments, the nanoparticles may be encapsulated with a hydroxyl functional fluorosurfactant and/or a hydroxyl functional polymer. Advantageously, the encapsulation of these nanoparticles may allow homogeneous dispersion of the nanoparticles within the cross-linked polymer matrix and further prevents the nanoparticles from being sloughed off the coating when contacted with abrasive forces.

The nanoparticles may have a uniform or a substantially uniform particle size distribution of about 1 nm to about 1000 nm, 5 nm to about 2000 nm, 5 nm to about 1,000 nm, 10 nm to 1000 nm, 10 nm to 900 nm, 10 nm to 800 nm, 10 nm to 700 nm, 10 nm to 600 nm, 10 nm to 500 nm, 10 nm to 400 nm, 10 nm to 300 nm, 10 nm to 200 nm, 10 nm to 100 nm, or 10 nm to 50 nm. In other embodiments, the nanoparticles have a particle size distribution of about 10 nm to about 100 nm, 10 nm to 30 nm, 10 nm to 50 nm, 10 nm to 70 nm, or 10 cm to 90 nm.

The photoinitiator compound can be any compound that is capable of initiating photo-polymerization of unsaturated functional groups (e.g., acrylates). Photoinitiator compounds may be capable of forming radicals upon absorbing radiation to thereby initiate, propagate or catalyze polymerization or cross-linking reactions in a mixture or composition to which they have been introduced. Suitable photoinitiator compounds can be broadly selected from optionally substituted aryls, carbocycles and mixtures thereof. In one embodiment, the photoinitiator compound is a hydroxyl-substituted cycloalkyl-aryl-ketone. In one embodiment, the photoinitator is exemplified by the commercial product Irgacure® 500, which is a 50/50 mixture of 1-hydroxy-cyclohexyl-phenyl-ketone and benzophenone.

The coating composition as described above is substantially hydrophilic or water-repellent and may exhibit a water contact angle of from about 20° to about 150°. In embodiments, the water contact angle is selected from the group consisting of: ≧21°, ≧22°, ≧23°, ≧24°, ≧25°, ≧26°, ≧27°, ≧28°, ≧29°, ≧30°, ≧31°, ≧32°, ≧33°, ≧34°, ≧35°, ≧36°, ≧37°, ≧38°, ≧38°, ≧39°, ≧40°, ≧41°, ≧42°, ≧43°, ≧44°, ≧45°, ≧46°, ≧47°, ≧48°, ≧49°, ≧50°, ≧51°, ≧52°, ≧53°, ≧54°, ≧55°, ≧56°, ≧57°, ≧58°, ≧59°, ≧60°, ≧61°, ≧62°, ≧63°, ≧64°, ≧65°, ≧66°, ≧67°, ≧68°, ≧69°, ≧60°, ≧71°, ≧72°, ≧73°, ≧74°, ≧75°, ≧76°, ≧77°, ≧78°, ≧79°, ≧80°, ≧81°, ≧82°, ≧83°, ≧84°, ≧85°, ≧86°, ≧87°, ≧88°, ≧89°, ≧90°, ≧92°, ≧94°, ≧96°, ≧98°, ≧100°, ≧102°, ≧104°, ≧106°, ≧108°, ≧110°, ≧112°, ≧114°, ≧116°, ≧118°, ≧120°, ≧122°, ≧124°, ≧126°, ≧128°, ≧130°, ≧132°, ≧134°, ≧136°, ≧138°, ≧140°, ≧142°, ≧144°, ≧146°, ≧148° and ≅150°.

In embodiments, a coating composition as described above is substantially oil-repellent and may exhibit an oil (hexadecane) contact angle of at least 40°, at least 50°, at least 60°, at least 70°, at least 80° or at least 90°. Advantageously, the coating composition may possess an oil (hexadecane) contact angle selected from the group consisting of: ≧40°, ≧41°, ≧42°, ≧43°, ≧44°, ≧45°, ≧46°, ≧47°, ≧48°, ≧49°, ≧50°, ≧51°, ≧52°, ≧53°, ≧54°, ≧55°, ≧56°, ≧57°, ≧58°, ≧59°, ≧60°, ≧61°, ≧62°, ≧63°, ≧64°, ≧65°, ≧66°, ≧67°, ≧68°, ≧69°, ≧70°, ≧71°, ≧72°, ≧73°, ≧74°, ≧75°, ≧76°, ≧77°, ≧78°, ≧79°, ≧80°, ≧81°, ≧82°, ≧83°, ≧84°, ≧85°, ≧86°, ≧87°, ≧88°, ≧89°, ≧90°, ≧91°, ≧92°, ≧93°, ≧94°, ≧95°, ≧96°, ≧97°, ≧98°, ≧99°, and ≧100°.

In embodiments, a coating composition as described above has substantially low surface energy selected from ≦35 mJ/m², ≦34 mJ/m², ≦33 mJ/m², ≦32 mJ/m², ≦31 mJ/m², ≦30 mJ/m², ≦29 mJ/m², ≦28 mJ/m², ≦27 mJ/m², ≦26 mJ/m², ≦25 mJ/m², ≦24 mJ/m², ≦23 mJ/m², ≦22 mJ/m², ≦21 mJ/m², ≦20 mJ/m², ≦19 mJ/m², ≦18 mJ/m², ≦17 mJ/m², ≦16 mJ/m², or ≦15 mJ/m².

Advantageously, it is postulated that the oleophobicity of the polymer causes reduced surface energy which allows the hyperbranched polymer to migrate towards the interface between the polymer coating and the ambient environment. This in turns provides repellency against dirt and organic particles that may come into contact with the polymer coating.

Also advantageously, the hydrophilicity of the polymer makes it aqueous or water-dispersible, allowing the polymer disclosed herein to be used in water-based coatings. When provided as a coating, the disclosed polymer also improves the wettability of the coating, allowing water to spread evenly over the coating surface, thereby reducing streak marks. The wettability further allows the dirt particles in contact with said coaing to be readily removed when washed with water.

### Reaction Scheme I

FIG. 1 shows an exemplary reaction mechanism involved in the disclosed method for preparing a polymer of formula (I) according to the present invention. The reaction scheme is for facilitating understanding of the chemistry involved and is not intended to be limiting on the scope of the present disclosure.

Step 1 of Reaction Scheme I shows the formation of a precursor compound having an unreacted, terminal cross-linkable group (exemplified by an isocyanate group “—N═C═O” or “—NCO”) and a terminal hydrophilic functional group. Step 1 comprises the reaction of a compound having at least two cross-linkable functional groups (exemplified here by diisocyanate groups) and a hydroxyl-functional compound having a hydrophilic moiety.

During the reaction of step 1, the hydroxyl group forms a carbamate bond (not explicitly shown) with one of the cross-linkable —NCO group to thereby yield the precursor compound having one unreacted, terminal cross-linkable —NCO group and a terminal hydrophilic functional group.

Similarly, step 2 of the reaction Scheme I involves the reaction of a compound having at least two cross-linkable —NCO groups and a hydroxyl-functional compound having an oleophobic moiety. During the reaction of step 1, the hydroxyl group forms a carbamate bond (not explicitly shown) with one of the cross-linkable —NCO group to thereby yield the precursor compound having an unreacted, terminal cross-linkable —NCO group and a terminal oleophobic functional group.

Steps 1 and 2 of Scheme I can be performed concurrently or sequentially. Steps 1 and 2 are preferably performed under room temperature conditions optionally in the presence of one or more catalysts compounds. The precursor compounds obtained from steps 1 and 2 may be provided as a single mixture of precursor compounds or separate mixtures. In addition to steps 1 and 2, additional precursor compounds are also contemplated which contain one terminal cross-linkable —NCO group and an additional functional group which is crosslinkable. This additional functional group can be —NCO as well (as shown in step 3).

Step 3 of Reaction Scheme I shows the reaction between the precursor compounds of step 1, the precursor compounds of step 2, and a precursor compound having cross-linkable groups, with a polymer P having y number of pendant reactive groups (exemplified here by hydroxyl groups). The third precursor compound having cross-linkable groups may have identical or different cross-linking moiety. In embodiments, at least one of the cross-linking moiety is an isocyanate moiety or at least one cross-linking moiety is reactive with the pendant reactive group of polymer P. Advantageously, at least one or both cross-linking moieties of the third precursor compound are reactive at room temperatures. The stoichiometry of reactants in reaction step 3 can be appropriately adjusted or controlled to yield the desired extent of substitution of —OH groups with hydrophilic groups, oleophobic groups or cross-linkable groups. In Reaction Scheme I, there is shown n molecules of a first precursor (step 1), m molecules of a second precursor (step 2), and q molecules of the third precursor being reacted with the polymer P to yield m number of olephobic groups, n number of hydrophilic groups, q number of cross-linkable groups, and optionally (y−(m+n+q))number of remaining unreacted —OH groups.

It will be appreciated that the described reaction mechanism can be generically applied for grafting various hydrophilic/oleophobic/cross-linkable moieties onto the polymer P via the formation of appropriate precursor compounds having at least one terminal, cross-linkable group. The present invention contemplates the use of such reaction mechanism to provide a modified polymer P having a plurality of hydrophilic groups, oleophobic groups, photo-sensitive groups, radiation-curable groups, and other cross-linkable groups as disclosed herein.

### EXAMPLES

Non-limiting examples of the invention and comparative examples will be further described in greater detail by reference to specific Examples, which should not be construed as in any way limiting the scope of the invention.

Materials used

Below is a list of the raw materials used in the following Examples. The commercial trade names (in bold) of the following raw chemicals will be used in the Examples for convenience.
1.Boltorn H2O: Dendritic polymer with 16 peripheral hydroxyl groups (theoretical number), having a molecular weight of about 2100 g/mol, and a hydroxyl number of 490 to 530 mgKOH/g, procured from Perstorp Singapore Pte Ltd.
2. Boltorn H40: Dendritic polymer with 64 peripheral hydroxyl groups (theoretical number), having a molecular weight of about 5100 g/mol, and a hydroxyl number 470 to 500 mgKOH/g, procured from Perstorp Singapore Pte Ltd.
3.Boltorn H4001, light yellow liquid, the solid content being 50%-55%, provided by Perstorp company, the derivative of the fourth generation hyperbranched polyester, wherein the terminal hydroxyl functional groups are partially esterified by C₈-C₁₂ saturated fatty acids. The hydroxyl value is 300-340 mg KOH/g by solid content, and the acid value is 2-8 mg KOH/g.
4.Polyacrylate (NT1802): Proprietary acrylate polymer with solids content about 75% and hydroxyl value about 200 mg KOH/g.
5. 2-(perfluoroalkyl)ethanol (Forfluo 764A-M): a mixture of 2-(perfluorodecyl)ethanol, 2-(perfluorooctyl)ethanol, 2-(perfluorohexyl)ethanol provided by China Fluoro Technology Co., Ltd.
6. Irgacure 500: Photoinitiator comprising a 1:1 mixture by weight of 1-hydroxy-cyclohexy-phenyl-ketone and benzophenone.
7. Miscellaneous reagents:

Butyl acetate (BA)

Caprolactone

Glycidol

3-(triethoxysilyl)propyl isocyanate

isophorone diisocyanate (IPDI)

2-hydroxyethyl methacrylate (HEMA)

dipropylene glycol dimethyl ether (DMM),

dibutylin dilaurate (DBTDL), perfluorohexyl ethanol, and

2-(perfluorooctyl)ethanol were purchased from Sigma-Aldrich, United States of America.

### Contact Angle Measurement [Water or Oil]

In the context of the present specification, where reference is made to a contact angle measurement of water or oil, the following measurement protocol is used:

The water and oil (hexadecane) contact angle was measured at room temperature using a Rame-Hart 290-F3 goniometer equipped with a CCD camera. 3 mu.L deionized water or hexadecane was added onto the film by an auto-dispenser. High resolution camera and software were used to capture the profile of the liquid on the film and its contact angle was analyzed. The contact angle was measured immediately after the deionized water or hexadecane was disposed onto the film by the autodispenser.

### Surface Energy Measurement

In the context of the present specification, where reference is made to a surface energy measurement, the following measurement protocol is used:

The surface energy measurement employed two types of liquids, the water and oil (hexadecane). The geometric solution was computed using DROPimagine Advanced software provided by the Rame-Hart contact angle measurement machine. At least three measurements were taken for each sample and an average value was recorded.

### Example 1

### Preparation of Polymer Composition Comprising Fluorocarbon, MPEG and NCO Functional Groups

(1a) Preparation of IPDI-perfluoroalkyl ethanol Precursor (IPDI-PFE)

Under nitrogen atmosphere, perfluoroalkyl ethanol (72.18 g) is added in several portions to a mixture of IPDI (24.00 g), butyl acetate (“BA”) (24.00 g) and DBTDL (0.096 g). The mixture was stirred for 1 h at room temperature (“RT”) until NCO % reached a theoretical value of 3.0%.

### (1b) Preparation of IPDI-MPEG750 Precursor (IPDI-MPEG)

Under nitrogen atmosphere, a 80 wt % solution of MPEG750 in butyl acetate (323.9 g) was added slowly into a mixture of IPDI (64.00 g), butyl acetate (64.78 g) and DBTDL (0.323 g) at 25° C. The mixture was stirred at the 25° C. for 2 h until NCO % reached a theoretical value of 2.14%.

(1c) Preparation of Polymer having Hydrophilic+Oleophobic Functional Groups (H4001-MPEG40%-PFE10%)

Under nitrogen atmosphere, IPDI-PFE adduct (45.90 g) was added slowly into a mixture of H4001 (140.00 g) and DBTDL (0.140 g). The mixture was stirred at 80° C. for 30 min, following by addition of IPDI-MPEG adduct (259.20 g). Stirring was continued at the same temperature for 4 h until NCO % was less than 0.1%.

### (1d) Preparation of Polymer Composition (H4001-MPEG40%-PFE10%-HDI N3600)

Under nitrogen, the polymer prepared by step 1(c) [H4001-MPEG40%-PFE10%] (80 g) was added over 5 h into a mixture of an isocyanate cross-linker compound (Desmodur N3600) (76.00 g), butyl acetate (135.10 g) and DBTDL (0.080 g) at 80° C. The non-volatile content % (NVC%)of the polymer composition is about 50%.

### Example 2

### Preparation of Polymer Comprising Fluorocarbon, MPEG and Blocked-NCO Functional Groups

### (2a) Preparation of IPDI-Caprolactam/MPEG750/Perfluroalkylethanol Precursor:

Under nitrogen protection, at RT, to a mixture of IPDI (132.00 g), BA (144.40 g) and DBTDL (0.423 g), solid perfluoroalkylethanol or “PFE” (41.35 g) was added in one portion. The mixture was stirred at RT for 30 min, and then a solution of MPEG 750 in BA (267.90 g, 80 wt %) was added over 30 mins. After stirring at RT for another 30 min, caprolactam (35.30 g) was added in one portion and the resulting mixture was heated to 65° C. for about 3 h until NCO % reached a theoretical value of 3.5%. The resultant solution was allowed to cool to RT.

### (2b) Preparation of Polymer Composition Containing Caprolactam/MPEG750/Perfluoroalkylethanol:

Under nitrogen protection, to a mixture of polyacrylate NT1802 (95.00 g) and DBTDL (0.095 g) at 80° C., the precursor mixture of 2(a) [IPDI-caprolactam/MPEG750/perfluoroalkylethanol] (308.30 g) was introduced over 30 min. The mixture was stirred at the same temperature for 8 h until NCO % is <0.1%. A GPC test yielded Mn=3189 and Mw=7466.

### Example 3

### Preparation of Polymer Composition Comprising Fluorocarbon, MPEG and Blocked-NCO Functional Groups

Under nitrogen protection, to a mixture of H4001 (117.00 g) and DBTDL (0.095 g) at 80° C., the precursor mixture (288.10 g) of Example 2(a) was added over 30 min. The mixture was stirred at the same temperature for about 8 h until NCO % is <0.2%. A GPC test yielded Mn=3959 and Mw=17363.

### Comparative Example 4

### Preparation of Polymer Composition without Fluorocarbon Functional Group (H40-IPDI-MPEG/DMP, in NMP)

### (4a) Preparation of IPDI-MPEG Adduct

Under nitrogen protection, a solution of MPEG 750 in NMP (101.22 g, 80 wt %) was added into a mixture of IPDI (20.00 g), DBTDL (0.101 g) and NMP (20.24 g) over 20 min with stirring. The resulting mixture was stirred at RT for about 3 h until NCO % reached 2.1%.

### (4b) Preparation of IPDI-DMP Adduct

Under nitrogen protection, DMP was added into a mixture of IPDI (24.00 g), NMP (12.45 g) and DBTDL (0.036 g) at RT. The mixture was heated and stirred at 70° C. for 1 h.

### (4c) Preparation of H40-IPDI-MPEG/DMP

Under nitrogen protection, a hydroxyl-terminated dendritic polyester [Bolton H40] (36.00 g) and NMP (36.00 g) were mixed and heated to 120° C. with stirring to yield a clear solution. The solution was cooled to 80° C. and treated with DBTDL (0.036 g). The precursor compound of 4(a) was added over 20 min, followed by addition of IPDI-DMP adduct as prepared in 4(b) over 30 min. The resulting mixture was stirred at 80° C. for about 3 h until NCO % was less than 0.1%. GPC (Mn, Mw): 17039, 24196.

### Comparative Example 5

### Preparation of Polymer Composition without Fluorocarbon Functional Group

### (5a) Preparation of IPDI-Caprolactam Precursor (IPDI-CL)

Under nitrogen protection, a mixture of IPDI (100.00 g), BA (80.00 g), caprolactam (61.10 g) and DBTDL (0.161 g) were stirred at 65° C. for about 2 h until NCO % reached theoretical value of 6.2%.

### (5b) Preparation of IPDI-MPEG750 Precursor

Under nitrogen protection, to a mixture of IPDI (64.00 g), BA (64.78 g) and DBTDL (0.323 g), a solution of MPEG 750 in BA (323.90 g, 80 wt %) was added over 30 min at RT. The resulting mixture was stirred at RT for about 4 h until NCO % reached theoretical value of 2.1%.

### (5c) Preparation of H4001-IPDI-CL-MPEG750

Under nitrogen protection, H4001 (100.00 g) was mixed with DBTDL (0.100 g) and heated to 80° C. IPDI-caprolactam precursor of 5(a) was added with stirring over 15 min at this temperature, followed by addition of the precursor compound of 5(b) over 30 min. The mixture was stirred at the same temperature for about 8 h until NCO % is less than 0.1%. A GPC test yielded Mw=9500, Mn=3300.

### Example 6

### Preparation of H20-Silane-MPEG-PFE

### (6a) Preparation of IPDI-MPEG/Perfluorohexyl Ethanol Adduct (IPDI-MPEG/PFE)

Under nitrogen, to a mixture of IPDI (58.00 g), DMM (69.6 g) and DBTDL (0.20 g), perfluorohexyl ethanol was added at RT over 20 min, followed by addition of MPEG 350 (55.83 g) over another 20 min. The mixture was stirred at RT for 2 h until NCO % reached 3.6%.

### (6b) Preparation of H20-Silane-MPEG-PFE

Under nitrogen atmosphere, a second-generation hydroxyl functional dendritic polyester having a theoretical peripheral hydroxyl functionality of 16 (Boltorn H20) (40.00 g) and DMM (32.00 g) were mixed and heated to 140° C. until H20 fully melted. Caprolactone was added to the resulting suspension (10.00 g) in one portion. The resulting mixture was stirred for 40 min at 140° C. and was cooled down to 80° C. DBTDL (0.082 g) and 3-(triethoxysilyl)propyl isocyanate (22.05 g) was then added. The resulting mixture was stirred at the same temperature for 2 h. IPDI-MPEG/PFE adduct of 6(a) was added and the mixture was stirred at 80° C. for 4 h until NCO % was less than 0.1%.

### Example 7

### Preparation of Polymer Composition Comprising Fluorocarbon, Epoxy, HEMA and MPEG Functional Groups

(7a) Preparation of IPDI Precursors with Mixture of Perfluoroethanols, MPEG 750, Glycidol and HEMA

Under dry air atmosphere, perfluoroalkyl ethanols (11.08 g) was slowly added to a mixture of IPDI (75.00 g), DMM (96.82 g) and DBTDL (0.172 g), MPEG 750 (87.31 g), glycidol (8.62 g), and HEMA (16.53 g), each in 30 min intervals. The mixture was stirred until NCO % reached a theoretical value of 4.2%.

### (7b) Preparation of Polymer Composition

Under nitrogen atmosphere, 44.0 grams of Boltorn H40 (a fourth-generation dendritic polyester having a theoretical number of 64 pendant hydroxyl groups) and DMM (22.00 g) were heated to 130° C. with stirring until the H40 polymer melted. Caprolactone (22.00 g) was charged into the mixture at this temperature in one portion. The resulting clear solution was stirred at 140° C. for 1 h until all caprolactone was consumed as monitored by GC. The mixture was cooled to 80° C.

Under dry air atmosphere the IPDI precursors (273.90 g) prepared in (7a) were added at this temperature and the mixture was stirred at the same temperature for 7 h until NCO % was less than 0.1%.

### Example 8

### Preparation of Coating Film

The moisture curable polymer composition from example 1 was casted onto a glass panel with 50 Micron draw down bar. The coating film was cured at room temperature for 7 days before the contact angle measurement.

The coating exhibited an oil (hexadecane) contact angle of 89° and had a calculated surface energy of 35.2 mJ/m².

TABLE 1
Coating performance from Example 1

| | Water contact | Oil contact | Surface |
|---|---|---|---|
| Sample name | angle (°) | angle (°) | energy (mJ/m²) |
| Example 1 | 67. 6 | 89 | 35.2 |

### Example 9

### Comparative Performance of Coating Compositions

Respective polymer compositions from examples 2,3,4,5 were casted onto a glass panel and a tin panel with a 50 Micron draw down bar. The coating film was cured at 180° C. for 60 min before contact angle measurement and pencil hardness measurement. The results are summarized in Table 2.

Notably, when compared to comparative examples 4 and 5, the coatings of example 2 and 3 demonstrated much higher oil (hexadecane) contact angles and lower surface energies.

TABLE 2

| | Water contact | Oil contact | Surface |
|---|---|---|---|
| Sample name | angle (°) | angle (°) | energy (mJ/m²) |
| Example 2 | 81 | 70.6 | 25.25 |
| Example 3 | 83.8 | 76.2 | 23.0 |
| Comparative | 70.1 | 32.8 | 36.9 |
| Example 4 | | | |
| Comparative | 81.3 | 30.7 | 31.0 |
| Example 5 | | | |

Pencil hardness on Tin panel (Mark/Break)

| | |
|---|---|
| Example 2 | B/B |
| Example 3 | HB/H |
| Comparative | B/H |
| Example 4 | |
| Comparative | HB/H |
| Example 5 | |

### Example 10

A room-temperature curable polymer composition prepared from Example 6 was casted onto a glass panel with 50 Micron draw down bar. The coating film was cured at room temperature for 7 days before contact angle measurement. The results are provided in Table 3.

TABLE 3
Coating performance from example 6

| | Water contact | Oil contact | Surface |
|---|---|---|---|
| Sample Name | angle (°) | angle (°) | energy (mJ/m²) |
| Example 6 | 112 | 82 | 10.47 |

### Example 11

### UV Curable Polymer Composition

A polymer composition prepared from Example 7 was mixed with 2% Irgacure 500 and casted onto a glass panel with 50 Micron draw down bar. The coating film was cured at Dymax UV curing system (5000-EC Series, Flood Lamp) for minutes before the contact angle measurement. The results are provided in Table 4.

TABLE 4
Coating performance from example 7

| | Water contact | Oil contact | Surface |
|---|---|---|---|
| Sample Name | angle (°) | angle (°) | energy (mJ/m²) |
| Example 7 | 97.5 | 86. 9 | 14.5 |

### Applications

The disclosed coating composition formed from a polymer of formula (I) displays superior resistance to dirt pick-up and formation of water streak marks. In an advantageous embodiment, the disclosed polymer composition comprises dendritic polymers as its polymer binder. Dendritic polymers modified with hydrophilic and oleophobic groups provide surface coatings that are highly resistant to both organic and aqueous solvents (e.g. methylethylketone, water). Concurrently, the disclosed coatings display pencil hardness of at least from HP to 7H. In some embodiments, the pencil hardness has been found to be greater than 2H, and in other embodiments, greater than 4H.

The disclosed polymer also advantageously provides coating compositions that are water dispersible such that the use of organic solvents is minimized or unnecessary. Consequently, the disclosed coating compositions have low or no emission of volatile organic compounds (VOCs), which may be flammable, emit an odor and are toxic to health and/or the environment.

In other embodiments, the disclosed coating compositions provide coatings having low surface energy and are therefore less susceptible or prone to fouling by surface contaminants. Specifically, it has been advantageously found that the dirt or water-resistant properties of the coatings are not adversely affected by exposure to moisture, e.g., water. The reason for the stable, long-lasting dirt/water-resistant properties is in part attributable to the low surface energy of these coatings.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A hyperbranched polymer having the following formula I: 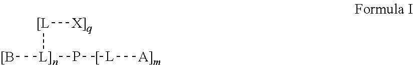
wherein the line “- - - ” represents a covalent bond, or a linkage group selected from: —NRC(O)O—, —C(O)OC(O)—NR—, —C(O)NR—, —NHC(O)NH—, wherein R is H, optionally substituted C₁-C₆ alkyl, C₁-C₆ heteroalkyl, carbocycle, aryl, or heteroaryl;
P is a hyperbranched polymer comprising y number of peripheral functional groups;
L is a linker moiety selected from optionally substituted, aliphatic, branched or cyclic alkyl, aryl, phenyl, or alkylene diphenyl;
A is a hydrophobic functional group;
B is a hydrophilic functional group selected from the group consisting of: alkoxy, amino, amide, ammonium, carboxyl, carboxylate, phosphoric acid groups, sulfonic acid groups, and combinations thereof; and
X is a cross-linkable functional group;
each of m, n and q are integers, wherein m, n and q are each greater than zero, and m+n+q≦y; and wherein the following conditions are met:
8≦y≦64;
0.1 y≦m≦0.6 y;
0.1 y≦n≦0.5 y; and
0.01≦q≦0.5 y.

2. The hyperbranched polymer of claim 1, wherein the following conditions are met:
8≦y≦64;
0.01 y≦m≦0.4 y;
0.2 y≦n≦0.4 y; and
0.1≦q≦0.5 y.

3. The hyperbranched polymer of claim 1, wherein said hydrophilic functional group B is selected from polyethylene oxide, a primary amino group, a secondary amino group, a tertiary amino group, or a quaternary ammonium salt.

4. The hyperbranched polymer of claim 1, wherein said hydrophobic functional group A is an oleophobic group, wherein said oleophobic group is a polysiloxane, fluoroalkyl, fluorinated heteroalkyl, or a fluorinated alkoxy.

5. (canceled)

6. The hyperbranched polymer of claim 4, wherein said hydrophobic functional group A is a fluorinated alkyl having the following Formula III:
CF₃(CF₂)ᵤCH₂CH₂O—* Formula III
wherein *denotes an attachment point and u is an integer from 1 to 12.

7. The hyperbranched polymer of claim 1, wherein said hydrophilic functional group B comprises an alkoxy functional group 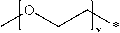
and additionally one or more of the following: amino, amide, ammonium, carboxyl, phosphoric acid groups, sulfonic acid groups, carboxylate, and combinations thereof,
wherein * denotes the point of attachment; and v is an integer from 1 to 50.

8. The hyperbranched polymer of claim 1, wherein L is selected from the group consisting of: 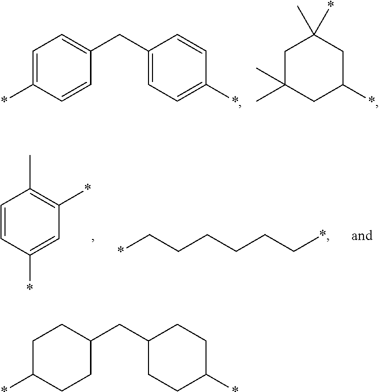
wherein * denotes an attachment point.

9. (canceled)

10. The hyperbranched polymer of claim 1, wherein hyperbranched polymer P is a dendritic polyester having y number of reactive peripheral hydroxyl groups.

11. The hyperbranched polymer of claim 1, wherein cross-linkable functional group X is selected from isocyanate, blocked isocyanate, epoxy, acrylate and silane, or mixtures thereof.

12. A method of forming a hyperbranched polymer for use in a coating composition, the method comprising the steps of:
a) providing precursor compounds comprising at least one terminal cross-linkable group and at least an additional functional group selected from a hydrophobic functional group, a hydrophilic functional group, or a cross-linkable group;
b) forming a covalent bond between the terminal cross-linkable group of said precursor compound with a peripheral reactive group of a polymer to thereby form a polymer having the following formula I: 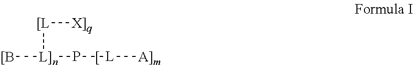
wherein the line “- - - ” represents a covalent bond, or a linkage group selected from: —NRC(O)O—, —C(O)OC(O)—NR—, —C(O)NR—, —NHC(O)NH—, wherein R is H, optionally substituted C₁-C₆ alkyl, C₁-C₆ heteroalkyl, carbocycle, aryl, or heteroaryl;
P is a hyperbranched polymer comprising y number of peripheral functional groups;
L is a linker moiety selected from optionally substituted, aliphatic, branched or cyclic alkyl, aryl, phenyl, or alkylene diphenyl;
A is a hydrophobic functional group;
B is a hydrophilic functional group selected from the group consisting of: alkoxy, amino, amide, ammonium, carboxyl, carboxylate phosphoric acid groups, sulfonic acid groups, and combinations thereof; and
X is a cross-linkable functional group;
each of m, n and q are integers, wherein m, q and n are each greater than zero, and m+n+q≦y; and further wherein the following conditions are met:
8≦y≦64;
0.1 y≦m≦0.6 y;
0.1 y≦n≦0.5 y; and
0.01≦q≦0.5 y.

13. The method of claim 12, wherein said cross-linkable group X is selected from the group consisting of: isocyanate, blocked isocyanate, epoxy, acrylate and silane, and mixtures thereof.

14. The method of claim 12, wherein said forming step (b) is undertaken at stoichiometric conditions to form said polymer of formula (I) where m is between 0.1 y to 0.4 y and wherein n is between 0.2 y to 0.4 y.

15. (canceled)

16. The method of claim 12, wherein said forming step (b) is undertaken at stoichiometric conditions to form said polymer of formula (I) wherein q is between 0.2y to 0.4y.

17. (canceled)

18. The method of claim 12, wherein L is selected from the group consisting of: 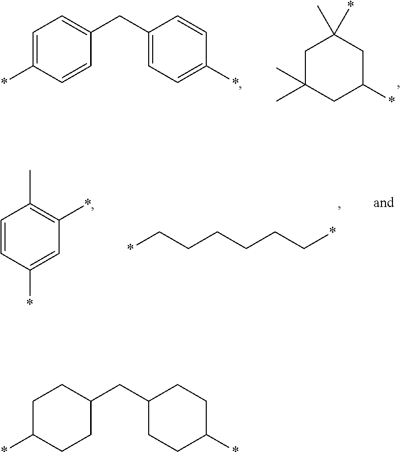
wherein * denotes an attachment point.

19. The method of claim 12, wherein providing step (a) comprises reacting a compound comprising at least two cross-linkable terminal groups with a fluorinated alcohol and an alkoxyalcohol.

20. The method of claim 19, wherein providing step (a) comprises reacting said compound comprising at least two cross-linkable terminal groups with:
a fluorinated alcohol;
a polyethylene oxide;
and one or more additional compounds selected from the group consisting of: epoxide alcohol, aminoalkoxysilane, alkyl acrylate, cyclic amide, heterocycloalkyl and mixtures thereof.

21. The method of claim 20, wherein forming step (a) comprises reacting said compound comprising at least two cross-linkable functional group with:
fluorinated alcohol;
polyethylene oxide; aminoalkoxysilane; and epoxide alcohol.

22. The method of claim 12, wherein prior to step (b), the method further comprising a step (al) of reacting said polymer P with caprolactam or c-caprolactone to form a chain extended polymer P1 having y number of peripheral groups.

23. A coating composition comprising a hyperbranched polymer P according to claim 1.

24. The coating composition of claim 23, further comprising one or more of the following:
b) nanoparticles having a particle size of between 5 to 2000 nm;
c) at least one photoinitiator compound; and
d) cross-linking catalyst.
